(19) United States
(12) Patent Application Publication
(10) Pub. No.: US 2025/0308197 A1
(43) Pub. Date: Oct. 2, 2025

(54) METHODS AND APPARATUS FOR SMALL OBJECT DETECTION IN IMAGES AND VIDEOS

(71) Applicant: INTEL CORPORATION, Santa Clara, CA (US)

(72) Inventors: Ping GUO, Beijing (CN); Haoran WEI, Santa Clara, CA (US); Bing WANG, Santa Clara, CA (US); Peng WANG, Beijing (CN); Xiangbin WU, Beijing (CN)

(73) Assignee: INTEL CORPORATION, Santa Clara, CA (US)

(21) Appl. No.: 18/863,557

(22) PCT Filed: Jun. 6, 2022
(86) PCT No.: PCT/CN2022/097128

§ 371 Date: Nov. 6, 2024

(51) Int. Cl. G06V 10/44; G06V 10/46; G06V 10/74; G06V 10/77; G06V 10/82

(52) U.S. Cl. CPC G06V 10/44; G06V 10/462; G06V 10/761; G06V 10/7715; G06V 10/82

(57) ABSTRACT

Methods, apparatus, systems, and articles of manufacture are disclosed for small object detection in images and videos. An example apparatus for small object detection includes a memory, computer readable instructions, and at least one processor to execute the computer readable instructions to at least receive an input image, identify a first grouping reference box for a first object representation in the input image, the first grouping reference box based on feature extraction performed with a feature extractor network, extract a first coordinate and a second coordinate for a corner location from a heatmap, the heatmap used to determine the first grouping reference box, generate a second grouping reference box for the first object representation based on the corner location, and update the first grouping reference box with the second grouping reference box.

### FIELD OF THE DISCLOSURE

This disclosure relates generally to computing systems, and, more particularly, to methods and apparatus for small object detection in images and videos.

### BACKGROUND

Object detection in images and videos is a common computer vision task. Object detection has been widely used in various applications such as intelligent transportation, smart retail, robotics, and aerospace, among others. Existing object detection methods include one-stage, two-stage, anchor-based, and anchor-free. In some examples, key-point based methods are used for small object and occlusion detection.

### BRIEF DESCRIPTION OF THE DRAWINGS

FIG. 1 illustrates example known small object detection and compares to small object detection disclosed herein using single-stage soft-grouping non-maximum suppression (SG-NMS).

FIG. 2 illustrates the single-stage soft-grouping non-maximum suppression (SG-NMS) for small object detection of FIG. 1 including object detector circuitry constructed in accordance with teachings of this disclosure.

FIG. 3 is a block diagram of an example implementation of the object detector circuitry of FIG. 2.

FIG. 4 is a flowchart representative of example machine readable instructions which may be executed to implement the object detector circuitry of FIG. 3.

FIG. 5 is a flowchart representative of example machine readable instructions which, when executed by the object detector circuitry of FIG. 2, cause the object detector circuitry to train a neural network to determine keypoint(s) as part of a convolutional encoder-decoder network for keypoint-based detection.

FIG. 6 is a flowchart representative of example machine readable instructions which may be executed to group corner keypoints using a soft-grouping (SG) algorithm and non-maximum suppression (NMS) using the object detector circuitry of FIG. 3.

FIG. 7 is a flowchart representative of example machine readable instructions which, when executed by the object detector circuitry of FIG. 2, cause the object detector circuitry to train a neural network to determine width and/or height of a grouping reference box (GRB) as part of a convolutional encoder-decoder network for keypoint-based detection.

FIG. 8 illustrates example steps of an algorithm representative of the soft-grouping (SG) and non-maximum suppression (NMS) soft object detection disclosed herein.

FIG. 9 illustrates an example chart showing object detection performance using anchor-based and anchor-free methods, including the soft-grouping (SG) and non-maximum suppression (NMS) soft object detection disclosed herein.

FIG. 10 is a block diagram of an example processing platform including processor circuitry structured to execute the example machine readable instructions of FIGS. 4-7 to implement the object detector circuitry of FIG. 2.

FIG. 11 is a block diagram of an example processing platform structured to execute the instructions of FIG. 5 to implement the example first computing system of FIG. 3.

FIG. 12 is a block diagram of an example processing platform structured to execute the instructions of FIG. 7 to implement the example second computing system of FIG. 3.

FIG. 13 is a block diagram of an example implementation of the processor circuitry of FIGS. 10, 11, 12.

FIG. 14 is a block diagram of another example implementation of the processor circuitry of FIGS. 10, 11, 12.

FIG. 15 is a block diagram of an example software distribution platform (e.g., one or more servers) to distribute software (e.g., software corresponding to the example machine readable instructions of FIGS. 10, 11, 12) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein “substantially real time” refers to occurrence in a near instantaneous manner recognizing there may be real world delays for computing time, transmission, etc. Thus, unless otherwise specified, “substantially real time” refers to real time+/−1 second. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events. As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

Methods and apparatus for small object detection in images and videos are disclosed herein. Object detection is used in computer vision tasks to infer information (e.g., three-dimensional information) for a given object identified in an image and/or a video. Object detection associated with computer vision tasks can be applicable in numerous fields, including robotics, autonomous driving, and/or augmented reality. In examples disclosed herein, “small” object detection refers to detection of object(s) in an image of interest that are in small sizes (e.g., including objects that can be physically large but occupy a small patch on an image and/or appear small compared to other object(s) in the image of interest). For example, small object detection presents challenges associated with the small representation of the given object(s) in the image of interest, given that the image can be in different resolution(s), such that the visual information for small object-based identification can be limited (e.g., small object(s) can be deformed and/or overlapped by larger object(s) in the image of interest).

Existing object detectors can implement clustering algorithms such as Non-Maximal Suppression (NMS) to perform post-processing on numerous boxes generated for each identified object in a given image. For example, NMS allows for the selection of one entity (e.g., a bounding box) from a multitude of overlapping entities (e.g., multiple bounding boxes used to represent an object detection). For example, object detectors can form a bounding box or window around a given object detected in an image, but there can be multiple bounding boxes generated for one single entity (e.g., thousands of windows of various sizes and shapes). NMS can be used to filter the resulting bounding boxes (e.g., using an Intersection over Union (IOU) metric) to select the bounding box(es) that represent the most accurate positioning of a given object or entity of interest. In some examples, NMS relies on selecting predictions with the maximum confidence while suppressing all other generated predictions (e.g., bounding boxes), therefore taking the maximum and suppressing the non-maximum predictions.

Successful object detection using known object detector(s) can also depend on effective feature extraction based on the detection of important image regions. Feature extraction can include keypoint detection, which refers to simultaneous detection of objects and the localization of their keypoints (e.g., spatial locations or points in an image that define an object and are invariant to rotation, shrinkage, distortion, etc.). In some examples, certain algorithms (e.g., CornerNet, CenterNet, CentripetalNet, etc.) can detect an object as a pair of keypoints (e.g., top-left corner and bottom-right corner of the bounding box, etc.). In some examples, such algorithms can use a convolutional network to generate a heatmap for certain corners (e.g., top-left corners, bottom-right corners, etc.) for all instances of an object. However, keypoint-based methods face challenges including hard-grouping (e.g., such methods depend on robust estimation of paired corner points, such that if one of the paired corners is incorrect, the rest of the grouping is inaccurate). Moreover, keypoint-based methods can rely on complex pipeline(s) with post-processing computation (e.g., such methods can use models that divide the grouping and NMS processes into two separate stages, which requires two separate calculations of distance measurements with a 2×O(n²) (Big-O) computational complexity). For example, CornerNet and its variants (e.g., CenterNet and CentripetalNet) define corner grouping and NMS as two additional stages, taking pre-defined two corner point(s) or one center point as a condition for grouping. Such techniques can introduce additional complexity and/or require additional computational resources that can limit computational efficiency for purposes of object detection.

Methods and apparatus disclosed herein introduce small object detection in images and/or videos using a simplified pipeline to improve object detection efficiency. In the examples disclosed herein, grouping and NMS phases are merged into a single stage and/or can share a distance metric calculation. Additionally, method and apparatus disclosed herein allow for a varied number of corner point(s) to boost object detection accuracy. In examples disclosed herein, Soft-Grouping Non-Maximum Suppression (SG-NMS) can be used for object detection by merging soft grouping with NMS into a single phase. As such, instead of using two separate distance metric calculations, distance computations can be shared between the SG and NMS stages for improved efficiency. In addition, a flexible number of estimated corners (e.g., 1 to 4) can be used while existing methods of keypoint-based object detection can depend on one fixed pair of two corners. Using methods and apparatus disclosed herein, the mean average precision for object detection is significantly improved. For example, known techniques that use a center-guided method for bounding box identification (e.g., Faster R-CNN, RetinaNet, FCOS, CenterNet, etc.) utilize center point(s) to model an object bounding box without corners grouping. However, the center point of an object box is not easy to locate accurately, given that a center point of a bounding box may need to be determined by all four boundaries of the instance (e.g., with four degrees of freedom), making such a known center-guided grouping-free manner difficult to produce high-quality detection boxes, especially towards small objects and occlusions. Methods and apparatus disclosed herein improve object detection efficiency for artificial intelligence-associated tasks that can be performed using grouping and/or NMS (e.g., face detection, human detection, action detection, etc.). In particular, methods and apparatus disclosed herein introduce linear efficiency and accuracy improvement using a generic modular algorithm that can linearly reduce the computational cost of conventional grouping and NMS (e.g., increasing accuracy by more than 6.2% with twice the processing speed).

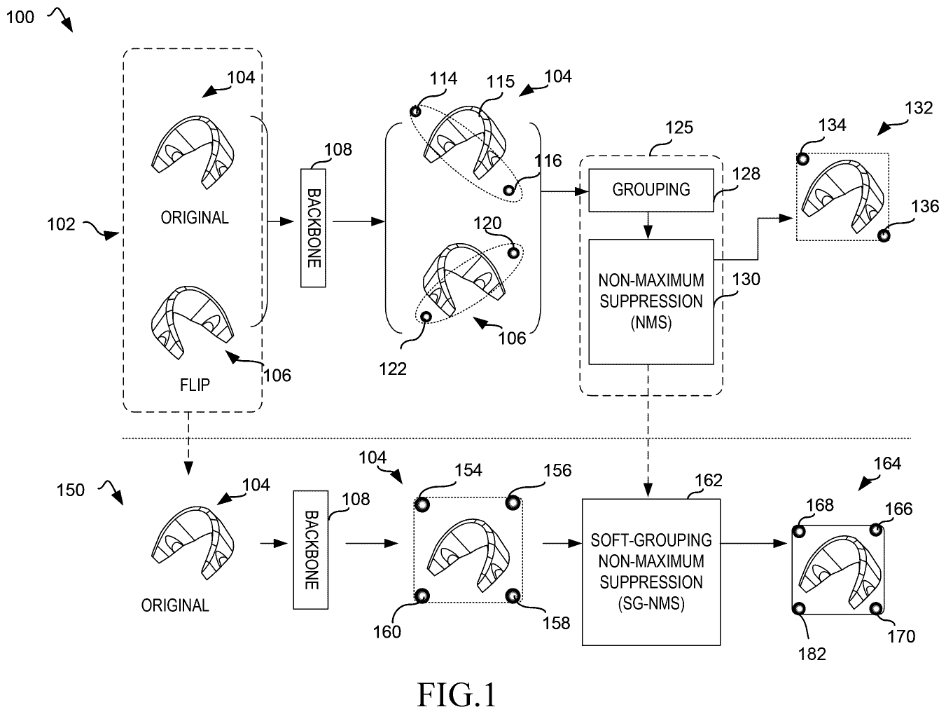

FIG. 1 illustrates example known small object detection 100 and compares to small object detection disclosed herein using single-stage soft-grouping non-maximum suppression (SG-NMS) 150. In the example of FIG. 1, a grouping of images 102 can be provided to a backbone 108 for processing as part of a convolutional neural network (CNN). For example, the grouping images 102 can include an original image 104 and a flipped image 106 of the original image 104. For example, the backbone 108 (e.g., a feature extractor network) can be a CNN for purposes of object detection applications involving classification, detection, or segmentation models. In some examples, the performance of object detection can be dependent on features extracted by the backbone 108 (e.g., using networks such as ResNet-50, ResNet-101, ResNet-152, etc.). In some examples, the backbone 108 can be used for object classification tasks, where a classifier classifies a single object in an image, outputs a single category per image, and/or provides the probability of matching a particular class. However, for purposes of object detection, several objects can be recognized in a single image and/or coordinates provided to identify the location of the object(s) in the image. For example, in FIG. 1, the image 104 includes an object (e.g., a first object 115) which can be recognized using an object detection technique. CNN-based object detectors can be classified into two-stage detectors (e.g., detectors performing region proposal generation on one network and object classification for each region proposal on another network) and one-stage detectors (e.g., detectors performing region proposal and object classification on a single network). For example, object detection can be performed by generating regions of interest (e.g., region proposals), which are a large set of bounding boxes spanning the full image (e.g., as part of object localization). Visual features can be extracted for each of the bounding boxes, with a determination of which objects are present in the region proposals based on visual features (e.g., object classification). Overlapping boxes can then be combined into a single bounding box using Non-Maximum Suppression (NMS).

In the example of FIG. 1, applying the backbone 108 (e.g., feature extractor network) in known small object detection 100, the feature extraction using images 104, 106 results in the identification of corners related to an object (e.g., first object 115). For example, known small object detection 100 can require the use of a fixed pair of two corners for object identification (e.g., a first fixed pair of corner(s) 114, 116 for the first object 115, a second fixed pair of corner(s) 120, 122 for the first object 115). For example, the fixed corner(s) can be identified for the first object 115 based on the original image 104 object 115 position and the flipped image 106 object 115 position. Known methods of object detection include separate stages for example grouping 128 and example Non-Maximum Suppression (NMS) 130, which can be performed in the post-feature extraction stage 125 of the object detection process. The separation of the grouping 128 and NMS 130 into two different stages can reduce network efficiency. Furthermore, the requirement for a fixed pair of corner(s) for object detection purposes can make detection of objects where a reduced number of identified corners is available more difficult. In the example of the known small object detection 100, the final object identification 132 includes corner point(s) 134, 136 for the first object 115.

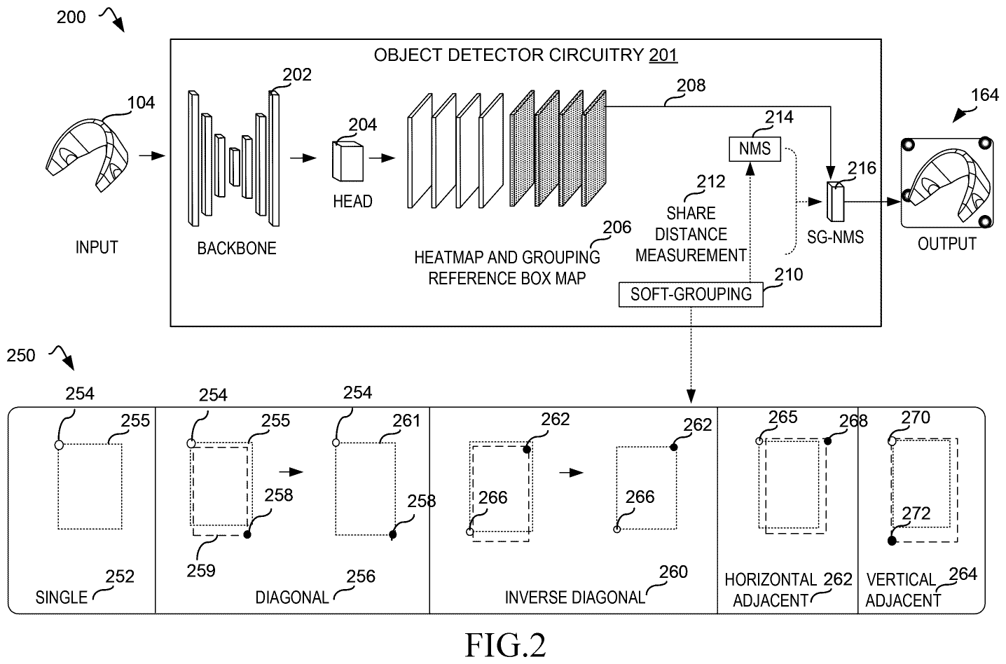

In the example of the SG-NMS-based object detection, the grouping 128 and NMS 130 stages of the known small object detection 100 are combined into a single stage for improved efficiency, as disclosed herein. For example, only the original image 104 is needed as input into the backbone 108 (e.g., feature extraction network). Likewise, a flexible number of corners can be used for object detection (e.g., corner(s) 154, 156, 158, 160 associated with the original image 104 feature extraction). In the example of FIG. 1, a combined soft-grouping Non-Maximum Suppression (SG-NMS) stage 162 can be used for the grouping 128 and NMS 130 stages, as described in connection with FIG. 2. The resulting object detection image 164 (e.g., including a bounding box for each object) can be obtained for the first object 115 (e.g., where the bounding box for the first object 115 is defined using corner point(s) 166, 168, 170, 182).

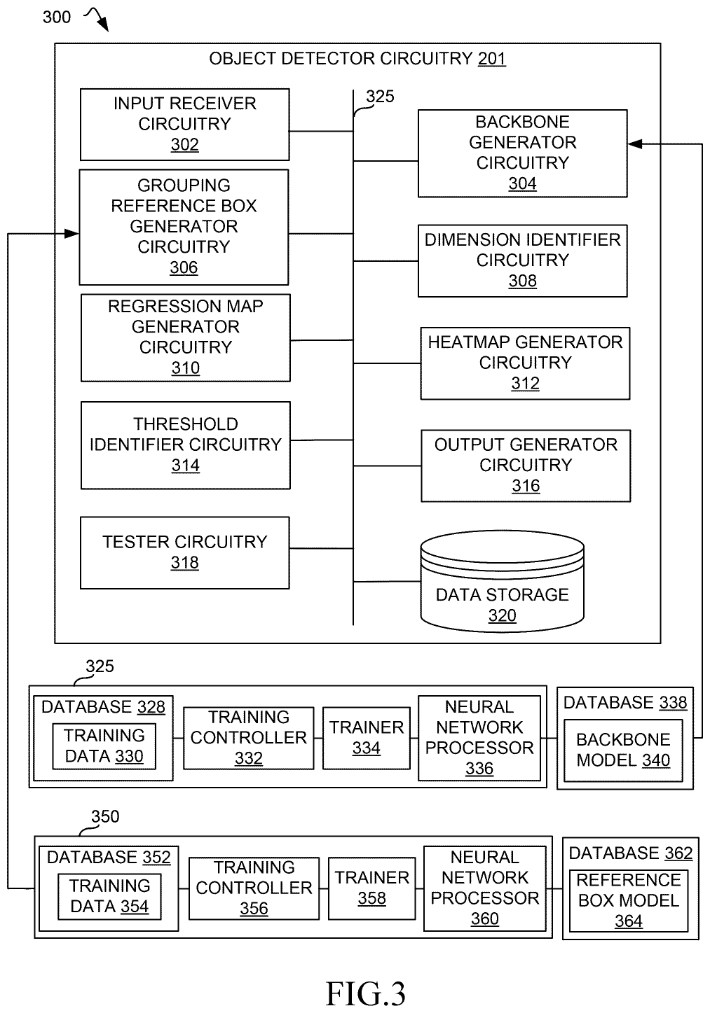

FIG. 2 illustrates an overview 200 of the single-stage soft-grouping non-maximum suppression (SG-NMS) 150 for small object detection of FIG. 1 including object detector circuitry 201 constructed in accordance with teachings of this disclosure. In the example of FIG. 2, the original image 104 of FIG. 1 is provided to the object detector circuitry 201, which includes a feature extractor network 202 (e.g., backbone 108 of FIG. 1). As described in connection with FIG. 1, the feature extractor network 202 can be a convolutional neural network (CNN) used to extract features associated with the input image 104. In some examples, the object detection model described herein can include a head 204 (e.g., a pre-trained backbone 108 and a random head 204 representing the top of a network). For example, a classification network can include a backbone and a fully connected layer as the sole prediction head. While the backbone 108 can be used to extract a feature map from the image (e.g., original image 104) that contains a high level of summarized information, the head 204 uses the feature map as input to predict a desired outcome. In the example of FIG. 2, a grouping reference box 206 is generated to be provided as input into the SG-NMS 150 algorithm. In some examples, the bounding box can be regressed in corner locations and corners extracted using heatmap(s). The grouping refence box 206 provides specific regression targets to allow the SG-NMS 150 algorithm to match the flexible (e.g., soft) number of corner(s) that belong to the same object instance (e.g., the first object 115, etc.). In the example of FIG. 2, the SG-NMS 150 algorithm can be used for several corner keypoints (e.g., all four corner keypoints) to match the corners to the same object instance and simplify and/or reduce the computational complexity of the post-processing steps for the corner-based object detection pipeline (e.g., using the grouping reference box (GRB) output 208). For example, the use of corner matching can be determined based on a distance metric of the corresponding GRBs (e.g., determined using the shared distance measurement 212), as described in more detail in connection with FIG. 3. In some examples, the distance metric can be based on an Intersection over Union (IoU) distance metric as part of an NMS algorithm 214. As such, the IoU distance measurement can be shared between the Soft-Grouping (SG) algorithm 210 and the NMS algorithm 214.

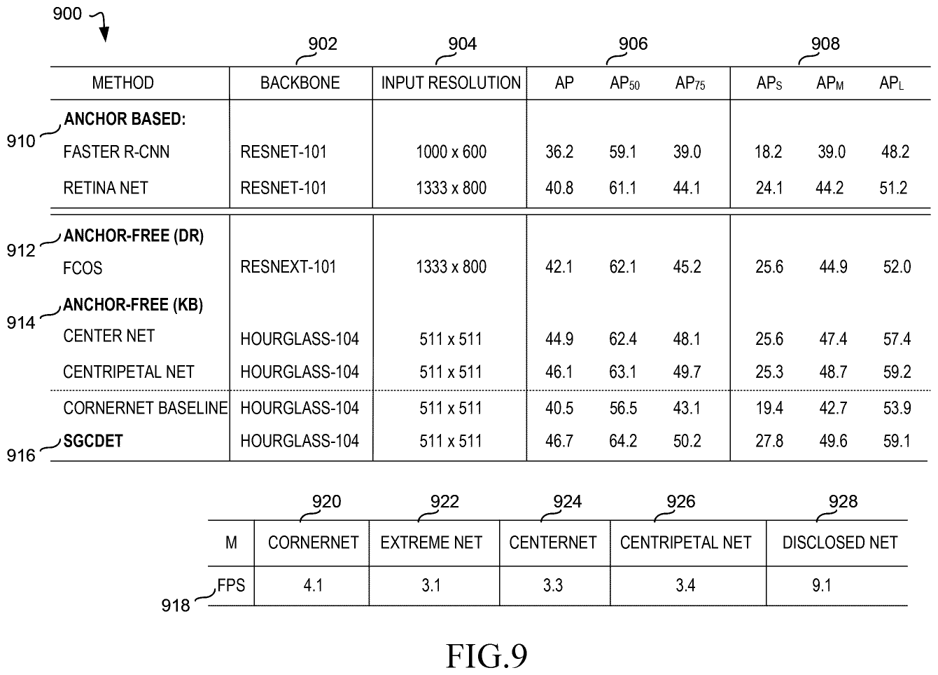

In the example of FIG. 2, the soft-grouping (SG) output 250 includes an illustration of corner point generation. Corner points can be generated as a single corner point 252, diagonal corner point(s) 256, inverse diagonal corner point(s) 260, horizontal adjacent corner point(s) 262, and/or vertical adjacent corner point(s) 264. For example, an upper left-hand corner 254 can be extracted based on single corner point 252 extraction. Diagonal corner point(s) 256 extraction can result in the identification of the upper left-hand corner 254 and a lower right-hand corner 258. In some examples, the corner(s) 254, 258 can be extracted using heatmaps, with dashed lines shown connecting the corner(s) 254, 258 representing regressed grouping reference boxes (GRBs) (e.g., a first GRB 255 determined using the upper left-hand corner 254, a second GRB 259 determined using the upper left-hand corner 254 and the lower right-hand corner 258, etc.). A heatmap represents a matrix filled with values from 0.0 to 1.0, where peaks on the heatmap indicate the presence of an object. In the example of FIG. 2, a third GRB 261 can be determined based on the first GRB 255 and the second GRB 259). For example, the single corner point 252 identification can be performed using a single GRB. As such, methods and apparatus disclosed herein allow for object-based identification using even a single keypoint (e.g., based on a GRB generated using the single corner point 252). In some examples, keypoints associated with the upper left-hand corner 254 and the lower right-hand corner 258 can be determined using a vanilla-based grouping process (e.g., a standard backpropagation algorithm), as described in more detail in connection with FIG. 3. In some examples, object detection can be performed based on any other number of available corner points (e.g., inverse diagonal corner point(s) 260 such as corner point(s) 262, 266, horizontal adjacent corner point(s) 262 such as corner point(s) 265, 268, and/or vertical adjacent corner point(s) 264 such as corner point(s) 270, 272). As such, any number of corner point(s) can be used for the generation of regressed grouping reference boxes as part of the soft-grouping (SG) output 250. In the example of FIG. 2, the soft grouping (SG) 210 and NMS 214 phases are merged into a single stage (e.g., SG-NMS 216) and can share a distance metric calculation (e.g., shared distance measurement 212). As such, instead of using two separate distance metric calculations, distance computations can be shared between the SG and NMS stages for improved object detection efficiency (e.g., object detection output 164 of FIG. 2). In addition, a flexible number of estimated corners (e.g., 1 to 4) can be used (e.g., while existing methods of keypoint-based object detection can depend on one fixed pair of two corners), thereby improving the mean average precision for object detection, as described in connection with FIG. 9.

FIG. 3 is a block diagram of an example implementation of the object detector circuitry of FIG. 2. In FIG. 3, the object detector circuitry 201 includes example input receiver circuitry 302, backbone generator circuitry 304, grouping reference box generator circuitry 306, dimension identifier circuitry 308, regression map generator circuitry 310, heatmap generator circuitry 312, threshold identifier circuitry 314, output generator circuitry 316, tester circuitry 318, and/or data storage 320.

The input receiver circuitry 302 receives an object image input (e.g., original image 104) and/or any other information associated with the object image input (e.g., image size, area of interest in the input object image, etc.). In some examples, the input receiver circuitry 302 can receive the object image input from a single source or multiple source(s) (e.g., digital images, videos, etc.).

The backbone generator circuitry 304 uses a feature extractor network to extract a feature map from the image (e.g., original image 104 obtained using the input receiver circuitry 302) that contains a high level of summarized information. For example, the backbone generator circuitry 304 can be a convolutional neural network for purposes of object detection applications involving classification, detection, or segmentation models. In some examples, the performance of object detection can be dependent on features extracted by the backbone generator circuitry 304 (e.g., using backbone 108) using networks such as ResNet-50, ResNet-101, ResNet-152, etc. In some examples, the backbone generator circuitry 304 can be used for object classification tasks, where a classifier classifies a single object in an image, outputs a single category per image, and/or provides the probability of matching a particular class. As illustrated in FIG. 3, the backbone generator circuitry 304 is in communication with a first computing system 325 that trains a neural network. As disclosed herein, the backbone generator circuitry 304 implements a neural network model to generate a backbone (e.g., backbone 108) for feature extraction.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In examples disclosed herein, deep neural network models are used. In general, machine learning models/architectures that are suitable to use in the example approaches disclosed herein will be based on supervised learning. However, other types of machine learning models could additionally or alternatively be used such as, for example, semi-supervised learning.

In general, implementing a ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.). Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, training can be performed based on early stopping principles in which training continues until the model(s) stop improving. In examples disclosed herein, training can be performed remotely or locally. In some examples, training may initially be performed remotely. Further training (e.g., retraining) may be performed locally based on data generated as a result of execution of the models. Training is performed using hyperparameters that control how the learning is performed (e.g., a learning rate, a number of layers to be used in the machine learning model, etc.). In examples disclosed herein, hyperparameters that control complexity of the model(s), performance, duration, and/or training procedure(s) are used. Such hyperparameters are selected by, for example, random searching and/or prior knowledge. In some examples re-training may be performed. Such re-training may be performed in response to new input datasets, drift in the model performance, and/or updates to model criteria and system specifications.

Training is performed using training data. In examples disclosed herein, the training data originates from previously generated images that include identified objects. If supervised training is used, the training data is labeled. In example disclosed herein, labeling is applied to training data based on, for example, the number of objects in the image data, etc. In some examples, the training data is sub-divided such that a portion of the data is used for validation purposes. Once training is complete, the model(s) are stored in one or more databases (e.g., database 320 of FIG. 3 and/or databases 328, 352 of FIG. 3).

Once trained, the deployed model(s) may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.). In some examples, output of the deployed model(s) may be captured and provided as feedback. By analyzing the feedback, an accuracy of the deployed model(s) can be determined. If the feedback indicates that the accuracy of the deployed model(s) is less than a threshold or other criterion, training of an updated model can be triggered using the feedback and an updated training data set, hyperparameters, etc., to generate an updated, deployed model(s).

As shown in FIG. 3, the first computing system 325 trains a neural network to generate a backbone model based on the input image (e.g., original image 104). The example computing system 325 includes a neural network processor 336. In examples disclosed herein, the neural network processor 336 implements a first neural network. The example first computing system 325 of FIG. 3 includes a first neural network trainer 334. The example first neural network trainer 334 of FIG. 3 performs training of the neural network implemented by the first neural network processor 336. The example first computing system 325 of FIG. 3 includes a first training controller 332. The example training controller 332 instructs the first neural network trainer 334 to perform training of the neural network based on first training data 330. In the example of FIG. 3, the first training data 330 used by the first neural network trainer 334 to train the neural network is stored in a database 328. The example database 328 of the illustrated example of FIG. 3 is implemented by any memory, storage device and/or storage disc for storing data such as, for example, flash memory, magnetic media, optical media, etc. Furthermore, the data stored in the example database 328 may be in any data format such as, for example, binary data, comma delimited data, tab delimited data, structured query language (SQL) structures, image data, etc. While the illustrated example database 328 is illustrated as a single element, the database 328 and/or any other data storage elements described herein may be implemented by any number and/or type(s) of memories.

In the example of FIG. 3, the training data 330 can include image data including object(s) in different locations or positions. The training data 330 can include features extracted based on the input image(s). The first neural network trainer 334 trains the neural network implemented by the neural network processor 336 using the training data 330. Based on the object(s) in the training data 330, the first neural network trainer 334 trains the neural network to recognize and/or extract features associated with the input image(s). A backbone model 340 is generated as a result of the neural network training. The backbone model 340 is stored in a database 338. The databases 328, 338 may be the same storage device or different storage devices. The backbone generator circuitry 304 executes the backbone model 340 to generate the backbone associated with the original image 104 (e.g., backbone(s) 108, 202), as described in connection with FIG. 2. In the example of FIG. 2, the backbone generator circuitry 304 is a convolutional neural network (CNN) that includes feature extraction and/or weight computation during the training process. In some examples, the feature extraction network associated with the backbone generator circuitry 304 includes convolutional and/or pooling layer pairs.

The grouping reference box generator circuitry 306 generates a grouping reference box (GRB) based on corner point(s) (e.g., corner point(s) 254, 258 of FIG. 2) identified as part of the feature extraction associated with the backbone generator circuitry 304. For example, the grouping reference box generator circuitry 306 can be used to predict a GRB based on the identified corner point(s). For example, top-left, bottom-right, top-right, and bottom-left corners can be represented as (tlₓ, tl_{y}), (brₓ, br_{y}), (trₓ, tr_{y}), and (blₓ,bl_{y}), respectively. The GRB can be defined as being equivalent to [(x, y), w, h] (e.g., GRB=[(x, y), w, h]) where w and h represent a width and a height and exist as a direction (“+” direction or “−” direction) that can be regressed at the corner location in accordance with Equations 1, 2, 3, and/or 4:

$${GRB}_{tl} = [ ( {tl}_{x} , {tl}_{y} ) , + \vert {br}_{x} - {tl}_{x} \vert , + \vert {br}_{y} - {tl}_{y} \vert ] \qquad Equation 1$$

$${GRB}_{br} = [ ( {br}_{x} , {br}_{y} ) , - \vert {tl}_{x} - {br}_{x} \vert , - \vert {tl}_{y} - {br}_{y} \vert ] \qquad Equation 2$$

$${GRB}_{tr} = [ ( {tr}_{x} , {tr}_{y} ) , - \vert {bl}_{x} - {tr}_{x} \vert , + \vert {bl}_{y} - {tr}_{y} \vert ] \qquad Equation 3$$

$${GRB}_{bl} = [ ( {bl}_{x} , {bl}_{y} ) , + \vert {tr}_{x} - {bl}_{x} \vert , - \vert {tr}_{y} - {bl}_{y} \vert ] \qquad Equation 4$$

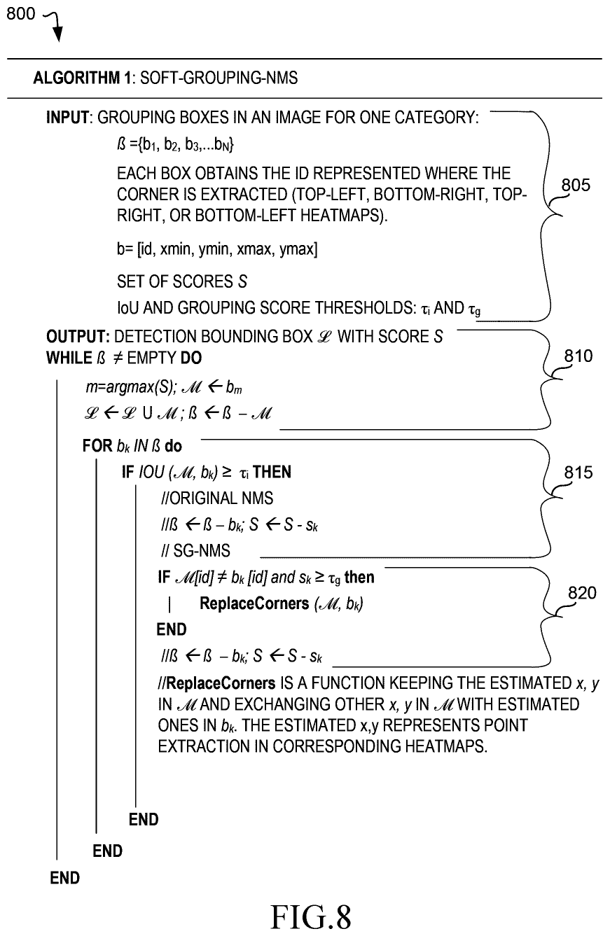

In some examples, the grouping reference box generator circuitry 306 can be used to generate four two-dimensional (e.g., width and height) regression maps for the grouping reference box (e.g., using the regression map generator circuitry 310). In examples disclosed herein, the grouping reference box generator circuitry 306 can be based on a reference box model (e.g., reference box model 364) generated using a second computing system 350, as described in more detail below. For example, during training (e.g., performed using a trainer 358), a smooth L1-loss can be used to train the width and height of each GRB. Smooth L1-loss represents a combination of L1-loss and L2-loss and can be used for box regression on object detection systems (e.g., using a loss function that is sensitive to outliers). In some examples, the grouping reference box generator circuitry 306 can use the regression map generator circuitry 310 and/or the heatmap generator circuitry 312 to decode the GRB at each corner location based on corner heatmap(s) and/or regression GRB map(s). In examples disclosed herein, the GRB is a key factor for devising the SG-NMS algorithm (e.g., SG-NMS 216 of FIG. 2). For example, if different identity (top-left, bottom-left, top-right, or bottom-left) corners belong to the same instance, their GRBs will overlap significantly, as shown in connection with FIG. 2. Therefore, as described in connection with FIG. 8, SG-NMS removes any GRB-based bₖ having greater overlap with a GRB-based top score, M (e.g., using vanilla NMS). In some examples, overlapping areas of intersection between two bounding boxes, divided by the total area of both bounding boxes, can be used to identify an accuracy score used to measure how close the two bounding boxes match. Unlike regular NMS, the SG-NMS algorithm disclosed herein (e.g., described in connection with FIG. 8) also retains the coordinate values xmin, ymin, xmax and/or ymax in M that are extracted in heatmaps and exchanges other coordinate values with the estimated ones in bₖ. This process is recursively repeated on the remaining GRBs. In some examples, the extracted coordinate values in heatmaps can be known with prior knowledge: (xmin, ymin) for top-left corner, (xmax, ymax) for bottom-right corner, (xmax, ymin) for top-left corner, and (xmin, ymax) for bottom-right corner. As such, grouping and NMS can be completed using a single algorithm as opposed to separate algorithms.

As shown in FIG. 3, the second computing system 350 trains a neural network to generate the reference box model 364 (e.g., using four two-dimensional (e.g., width and height) regression maps for the grouping reference box). The example second computing system 350 includes a neural network processor 360. In examples disclosed herein, the neural network processor 360 implements a second neural network. The second computing system 350 of FIG. 3 includes a second neural network trainer 358. The second neural network trainer 358 of FIG. 3 performs training of the neural network implemented by the second neural network processor 360. The second computing system 350 of FIG. 3 includes a second training controller 356. The training controller 356 instructs the second neural network trainer 358 to perform training of the neural network based on second training data 354. In the example of FIG. 3, the second training data 354 used by the second neural network trainer 358 to train the neural network is stored in a database 352. The database 352 of the illustrated example of FIG. 3 is implemented by any memory, storage device and/or storage disc for storing data such as, for example, flash memory, magnetic media, optical media, etc. Furthermore, the data stored in the example database 352 may be in any data format such as, for example, binary data, comma delimited data, tab delimited data, structured query language (SQL) structures, image data, etc. While the illustrated example database 352 is illustrated as a single element, the database 352 and/or any other data storage elements described herein may be implemented by any number and/or type(s) of memories.

In the example of FIG. 3, the training data 354 can include width and/or height data associated with regression maps for a grouping reference box. The second neural network trainer 358 trains the neural network implemented by the neural network processor 360 using the training data 354. The second neural network trainer 358 trains the neural network using a smooth L1-loss to train the width and height of each GRB. A reference box model 364 is generated as a result of the neural network training. The reference box model 364 is stored in a database 362. The databases 352, 362 may be the same storage device or different storage devices. The grouping reference box generator 306 executes the reference box model 364 to generate a grouping reference box (e.g., grouping reference box 206 of FIG. 2).

The dimension identifier circuitry 308 determines the shared distance metric (e.g., shared distance measurement 212 of FIG. 2). For example, the soft grouping (SG) 210 and NMS 214 phases are merged into a single stage (e.g., SG-NMS 216) and can share a distance metric calculation (e.g., shared distance measurement 212), allowing the use of corner matching to be determined based on a distance metric of the corresponding GRBs. In some examples, the dimension identifier circuitry 308 determined the distance metric based on an Intersection over Union (IoU) distance metric as part of an NMS algorithm 214. For example, the IoU evaluation metric can be used to measure the accuracy of an object detector on a particular dataset based on ground-truth bounding boxes (e.g., specifying where in the image an object of interest is present) and predicted bounding boxes (e.g., based on a model used to generate the bounding boxes). The IoU can be identified by calculating a ratio of an area of overlap between the bounding boxes (e.g., the predicted bounding box and the ground-truth bounding box) by an area of the union of the bounding boxes (e.g., area including both the predicted bounding box and the ground-truth bounding box). As such, an evaluation metric can be used that rewards predicted bounding boxes for heavily overlapping with the ground-truth bounding boxes.

The regression map generator circuitry 310 generates regression maps for the grouping reference box (GRBs). As such, the grouping reference box generator circuitry 306 can use the regression map generator circuitry 310 to decode the GRB at each corner location based on corner heatmap(s) and/or regression GRB map(s). For example, the regression map generator circuitry 310 can be used by placing a fully-connected layer with four neurons, corresponding to the top-left and bottom-right (x, y) coordinates. In some examples, a sigmoid activation function can be used such that the outputs are returned in the range [0,1]. Furthermore, the model can be trained using a loss function on training data that includes the input images and the bounding box of the object in the image. Once trained, the bounding box regressor network can receive an input image, which then performs a forward pass and predicts the output bounding box coordinates of the object.

The heatmap generator circuitry 312 can be used to generate heatmap(s). For example, the bounding box can be regressed in corner locations (e.g., using the regression map generator circuitry 310) and corners extracted using heatmap(s). The heatmap generator circuitry 312 generates a heatmap that is represented by a matrix filled with values from 0.0 to 1.0, where peaks on the map indicate the presence of an object. In some examples, the corner(s) 254, 258 of FIG. 2 can be extracted using heatmaps, with dashed lines shown connecting the corner(s) 254, 258 representing regressed grouping reference boxes (GRBs).

The threshold identifier circuitry 314 determines a threshold associated with the grouping reference box (GRB). For example, the object detector circuitry 201 removes GRB values overlapping with a maximum score determined in connection with a given GRB, as shown in connection with the example algorithm of FIG. 8. In some examples, the threshold identifier circuitry 314 removes any GRB-based bₖ having greater overlap with a GRB-based top score, M (e.g., using vanilla NMS). For example, overlapping areas of intersection between two bounding boxes, divided by the total area of both bounding boxes, can be used to identify an accuracy score used to measure how close the two bounding boxes match. For example, the threshold identifier circuitry 314 can be used to detect bounding boxes with high overlaps, which can correspond to the same object, such that the bounding boxes can be grouped and reduced to one box.

The output generator circuitry 316 generates the final output associated with the object detector circuitry 201. For example, as shown in connection with FIGS. 1-2, the object detection output 164 includes the final bounding box and/or identified corner point(s) associated with the detected object. In some examples, the output generator circuitry 316 includes other metrics associated with the object detection process (e.g., shared distance measurement, etc.).

The tester circuitry 318 can be used to perform linear efficiency and/or accuracy measurements. For example, the tester circuitry 318 can be used to verify that the computational cost of conventional grouping and NMS is linearly reduced using the methods and apparatus disclosed herein, as described in more detail in connection with FIG. 9. In some examples, the tester circuitry 318 can be used to evaluate an inference speed of a given model, which can further be used to determine algorithm efficiency.

The data storage 320 can be used to store any information associated with the input receiver circuitry 302, the backbone generator circuitry 304, the grouping reference box generator circuitry 306, the dimension identifier circuitry 308, the regression map generator circuitry 301, the heatmap generator circuitry 312, the threshold identifier circuitry 314, the output generator circuitry 316, and/or the tester circuitry 318. The example data storage 320 of the illustrated example of FIG. 3 can be implemented by any memory, storage device and/or storage disc for storing data such as flash memory, magnetic media, optical media, etc. Furthermore, the data stored in the example data storage 320 can be in any data format such as binary data, comma delimited data, tab delimited data, structured query language (SQL) structures, image data, etc.

While an example manner of implementing the object detector circuitry 201 of FIG. 2 is illustrated in FIG. 3, one or more of the elements, processes, and/or devices illustrated in FIG. 3 may be combined, divided, re-arranged, omitted, eliminated, and/or implemented in any other way. Further, the example input receiver circuitry 302, the example backbone generator circuitry 304, the example grouping reference box generator circuitry 306, the example dimension identifier circuitry 308, the example regression map generator circuitry 310, the example heatmap generator circuitry 312, the example threshold identifier circuitry 314, the example output generator circuitry 316, the example tester circuitry 318, and/or, more generally, the example object detector circuitry 201 of FIG. 2, may be implemented by hardware, software, firmware, and/or any combination of hardware, software, and/or firmware. Thus, for example, any of the example input receiver circuitry 302, the example backbone generator circuitry 304, the example grouping reference box generator circuitry 306, the example dimension identifier circuitry 308, the example regression map generator circuitry 310, the example heatmap generator circuitry 312, the example threshold identifier circuitry 314, the example output generator circuitry 316, the example tester circuitry 318, and/or, more generally, the example object detector circuitry 201 of FIG. 2, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). When reading any of the apparatus or system claims of this patent to cover a purely software and/or firmware implementation, at least one of the example input receiver circuitry 302, the example backbone generator circuitry 304, the example grouping reference box generator circuitry 306, the example dimension identifier circuitry 308, the example regression map generator circuitry 310, the example heatmap generator circuitry 312, the example threshold identifier circuitry 314, the example output generator circuitry 316, the example tester circuitry 318, and/or, more generally, the example object detector circuitry 201 of FIG. 2 is/are hereby expressly defined to include a non-transitory computer readable storage device or storage disk such as a memory, a digital versatile disk (DVD), a compact disk (CD), a Blu-ray disk, etc., including the software and/or firmware. Further still, the example object detector circuitry 201 of FIG. 2 may include one or more elements, processes, and/or devices in addition to, or instead of, those illustrated in FIG. 3, and/or may include more than one of any or all of the illustrated elements, processes and devices.

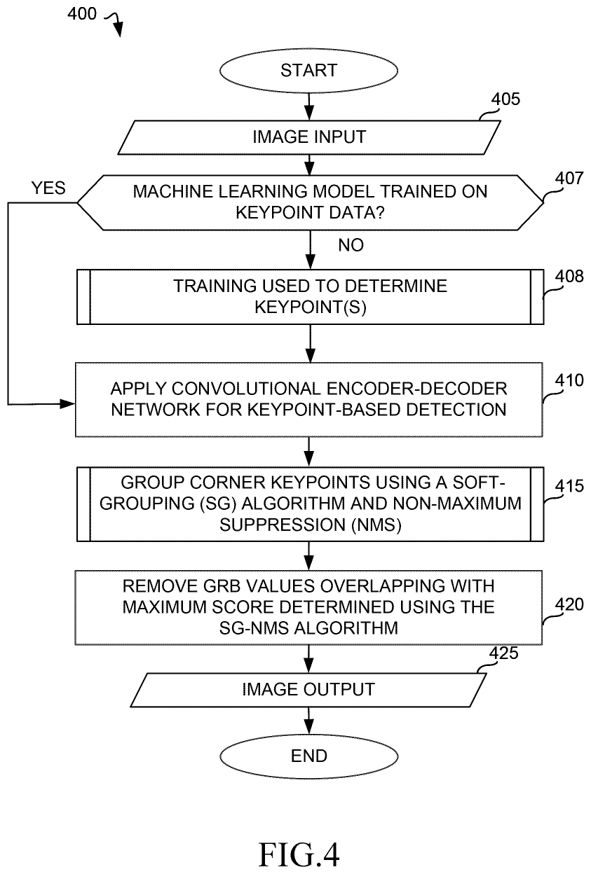

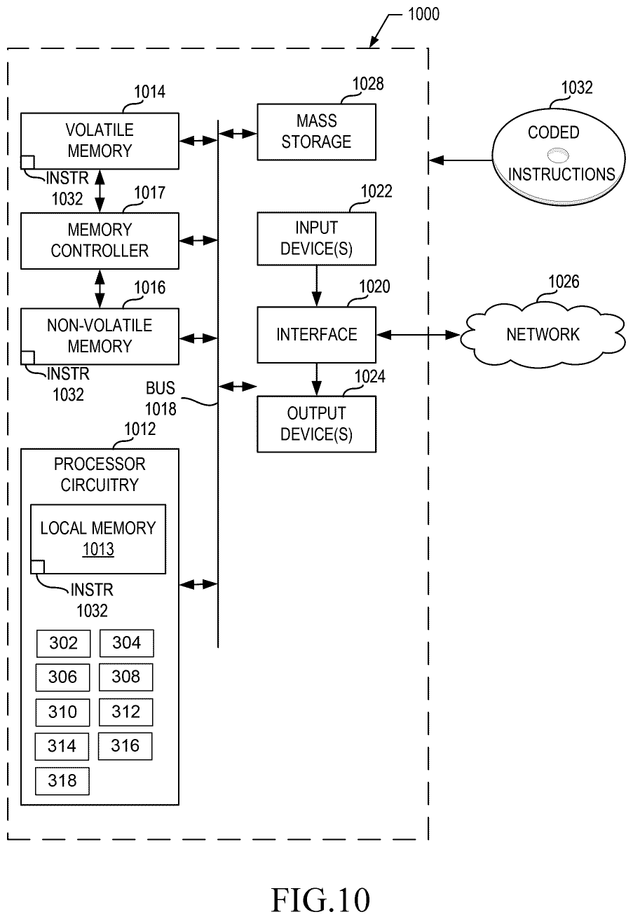

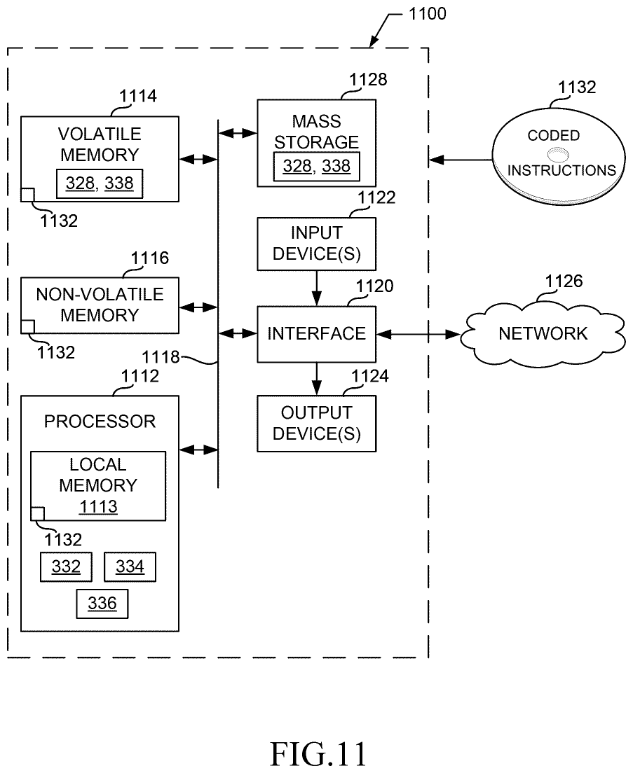

Flowcharts representative of example hardware logic circuitry, machine readable instructions, hardware implemented state machines, and/or any combination thereof for implementing the object detector circuitry 201 of FIG. 2 are shown in FIGS. 4-7. The machine readable instructions may be one or more executable programs or portion(s) of an executable program for execution by processor circuitry, such as the processor circuitry 1000 shown in the example processor platform 1000 discussed below in connection with FIG. 10 and/or the example processor circuitry discussed below in connection with FIGS. 11 and/or 12. The program may be embodied in software stored on one or more non-transitory computer readable storage media such as a CD, a floppy disk, a hard disk drive (HDD), a DVD, a Blu-ray disk, a volatile memory (e.g., Random Access Memory (RAM) of any type, etc.), or a non-volatile memory (e.g., FLASH memory, an HDD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4-7, many other methods of implementing the example object detector circuitry 201 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU), etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4-7 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium and non-transitory computer readable storage medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B.

As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second”, etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

While an example manner of implementing the first computing system 325 is illustrated in FIG. 3, one or more of the elements, processes and/or devices illustrated in FIG. 3 may be combined, divided, re-arranged, omitted, eliminated and/or implemented in any other way. Further, the example neural network processor 336, the example trainer 334, the example training controller 332, the example database(s) 328, 338 and/or, more generally, the example first computing system 325 of FIG. 3 may be implemented by hardware, software, firmware and/or any combination of hardware, software and/or firmware. Thus, for example, any of the neural network processor 336, the example trainer 334, the example training controller 332, the example database(s) 328, 338 and/or, more generally, the example first computing system 325 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the neural network processor 336, the example trainer 334, the example training controller 332, and/or the example database(s) 328, 338 is/are hereby expressly defined to include a non-transitory computer readable storage device or storage disk such as a memory, a digital versatile disk (DVD), a compact disk (CD), a Blu-ray disk, etc. including the software and/or firmware. Further still, the example first computing system 325 of FIG. 3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

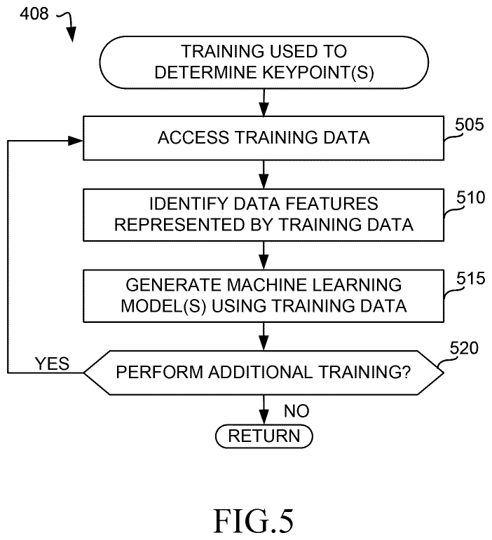

A flowchart representative of example hardware logic, machine readable instructions, hardware implemented state machines, and/or any combination thereof for implementing the example first computing system 325 of FIG. 3 is shown in FIG. 5. The machine-readable instructions may be an executable program or portion of an executable program for execution by a computer processor such as the processor 1112 shown in the example processor platform 1100 discussed below in connection with FIG. 11. The program(s) may be embodied in software stored on a non-transitory computer readable storage medium such as a CD-ROM, a floppy disk, a hard drive, a DVD, a Blu-ray disk, or a memory associated with the processor 1112 but the entire program and/or parts thereof could alternatively be executed by a device other than the processor 1112 and/or embodied in firmware or dedicated hardware.

While an example manner of implementing the second computing system 350 is illustrated in FIG. 3, one or more of the elements, processes and/or devices illustrated in FIG. 3 may be combined, divided, re-arranged, omitted, eliminated and/or implemented in any other way. Further, the example neural network processor 360, the example trainer 358, the example training controller 356, the example database(s) 352, 362 and/or, more generally, the example second computing system 350 of FIG. 3 may be implemented by hardware, software, firmware and/or any combination of hardware, software and/or firmware. Thus, for example, any of the example neural network processor 360, the example trainer 358, the example training controller 356, the example database(s) 352, 362 and/or, more generally, the example second computing system 350 of FIG. 3 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example neural network processor 360, the example trainer 358, the example training controller 356, and/or the example database(s) 352, 362 is/are hereby expressly defined to include a non-transitory computer readable storage device or storage disk such as a memory, a digital versatile disk (DVD), a compact disk (CD), a Blu-ray disk, etc. including the software and/or firmware. Further still, the example second computing system 350 of FIG. 3 may include one or more elements, processes and/or devices in addition to, or instead of, those illustrated in FIG. 3, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

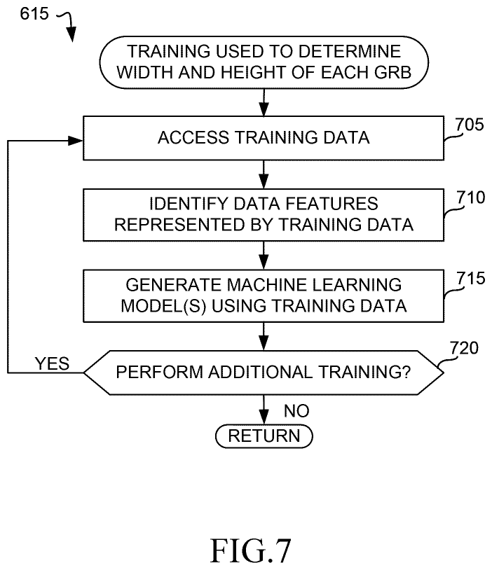

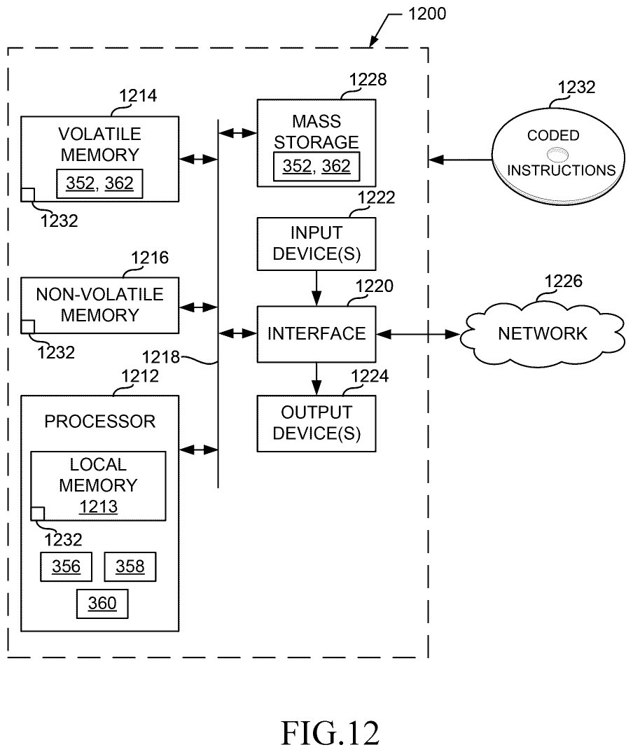

A flowchart representative of example hardware logic, machine readable instructions, hardware implemented state machines, and/or any combination thereof for implementing the example second computing system 350 of FIG. 3 is shown in FIG. 7. The machine readable instructions may be an executable program or portion of an executable program for execution by a computer processor such as the processor 1212 shown in the example processor platform 1200 discussed below in connection with FIG. 12. The program(s) may be embodied in software stored on a non-transitory computer readable storage medium such as a CD-ROM, a floppy disk, a hard drive, a DVD, a Blu-ray disk, or a memory associated with the processor 1212 but the entire program and/or parts thereof could alternatively be executed by a device other than the processor 1212 and/or embodied in firmware or dedicated hardware.

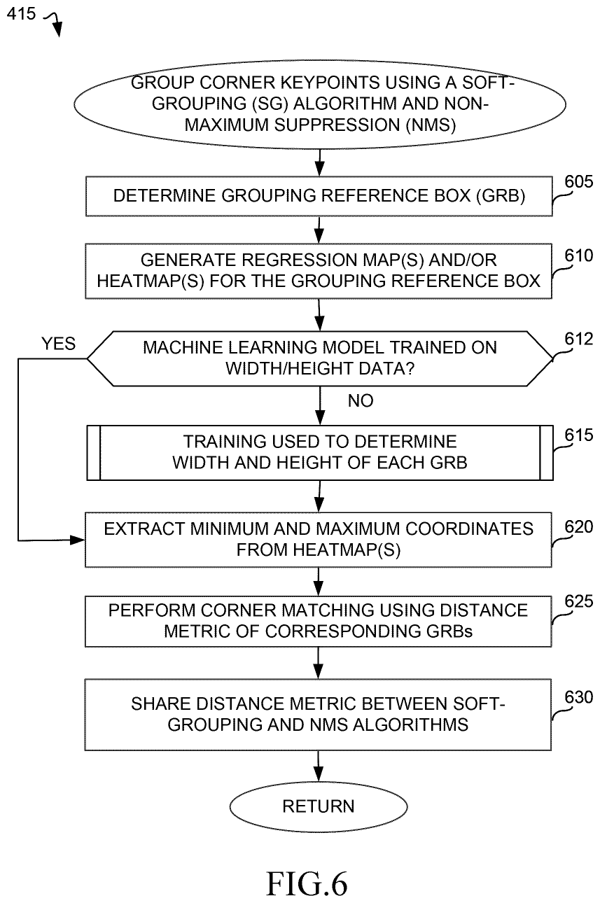

FIG. 4 is a flowchart representative of example machine readable instructions 400 which may be executed to implement the object detector circuitry 201 of FIG. 3. In the example of FIG. 4, the object detector circuitry 201 receives an image input (e.g., original image 104) using the input receiver circuitry 302 of FIG. 3 (block 405). When the backbone generator circuitry 304 determines that a machine learning model (e.g., backbone model 340 of FIG. 3) has been trained on keypoint data (block 407), the backbone generator circuitry 304 generates a backbone (e.g., backbone 202 of FIG. 2) based on the input image in order to perform feature extraction. For example, the backbone generator circuitry 304 applies a convolutional encoder-decoder network for keypoint-based detection (block 410). However, if the backbone generator circuitry 304 determines that the machine learning model (e.g., backbone model 340 of FIG. 3) has not been trained, control proceeds to the first computing system 325 of FIG. 3 to train the model to determine keypoint(s) (e.g., extract features based on the input image) (block 408). Once the keypoint(s) have been extracted using the backbone generator circuitry 304 based on the trained backbone model 340 of FIG. 3, the object detector circuitry 201 groups corner keypoint(s) using the soft-grouping (SG) algorithm (e.g., soft-grouping 210 of FIG. 2) and the non-maximum suppression (NMS) algorithm (e.g., NMS 214 of FIG. 2) (block 415), as described in more detail in connection with FIG. 6. For example, the object detector circuitry 201 uses the regression map generator circuitry 310 and/or the heatmap generator circuitry 312 to determine corner(s) (e.g., corner(s) 254, 258 of FIG. 2) using heatmaps, where the corner(s) can be connected using a regressed grouping reference box (GRB) determined using the regression map generator circuitry 310. In some examples, the dimension identifier circuitry 308 can be used to determine a shared distance measurement (e.g., shared distance measurement 212). In some examples, the distance metric can be based on an Intersection over Union (IoU) distance metric as part of an NMS algorithm 214. As such, the IoU distance measurement can be shared between the Soft-Grouping (SG) algorithm 210 and the NMS algorithm 214. In some examples, the threshold identifier circuitry 314 determines a threshold associated with the grouping reference box (GRB). For example, the object detector circuitry 201 removes GRB values overlapping with a maximum score determined in connection with a given GRB, as described in connection with FIG. 3 (block 420). The output generator circuitry 316 can be used to output the final image (e.g., object detection output 164), which includes the bounding box identifying each of the objects within the image (block 425), as shown in connection with FIG. 2.

FIG. 5 is a flowchart representative of example machine readable instructions 408 which, when executed by the object detector circuitry of FIG. 2, cause the object detector circuitry 201 to train a neural network to determine keypoint(s) as part of a convolutional encoder-decoder network for keypoint-based detection. In the example of FIG. 5, the trainer 334 accesses training data 330 (block 505). The training data 330 can include image data including extracted features (e.g., identified keypoints). The trainer 334 identifies data features represented by the training data 330 (e.g., data features to extract keypoints) (block 510). The training controller 332 instructs the trainer 334 to perform training of the neural network using the training data 330 to generate a backbone model 340 (block 515). In some examples, additional training is performed to refine the model 340 (block 520).

FIG. 6 is a flowchart representative of example machine readable instructions 415 which may be executed to group corner keypoints using a soft-grouping (SG) algorithm and non-maximum suppression (NMS) using the object detector circuitry 201 of FIG. 3. In the example of FIG. 6, the grouping reference box generator circuitry 306 determines the grouping reference box(es) (GRBs) for object(s) identified in the input image (e.g., original image 104) (e.g., GRBs 206 of FIG. 2) (block 605). The regression map generator circuitry 310 and/or the heatmap generator circuitry 312 can be used to generate regression map(s) and/or heatmap(s) for the grouping reference boxes (GRBs) (block 610). In some examples, the grouping reference box generator circuitry 306 determines whether a machine learning model has been trained on width and/or height data associated with GRBs (block 612). If the training has been performed, the grouping reference box generator circuitry 306 can be used to extract minimum and/or maximum coordinates from the heatmap(s) (block 620). If the training has not been performed, control proceeds to the second computing system 350 to perform training to determine width and/or height of each GRB (block 615), as described in more detail in connection with FIG. 7. Once the grouping reference box generator circuitry 306 extracts the minimum and/or maximum coordinates from the heatmap(s) determined using the heatmap generator circuitry 312 (block 620), as described in connection with FIG. 3, the object detector circuitry 201 performs corner matching using a distance metric of the corresponding GRBs (block 625). For example, the dimension identifier circuitry 308 determines a shared distance measurement 212 based on an Intersection over Union (IoU) distance metric as part of an NMS algorithm 214. As such, the dimension identifier circuitry 308 shares the distance metric between the SG 210 and NMS 214 algorithms (block 630).

FIG. 7 is a flowchart representative of example machine readable instructions 615 which, when executed by the object detector circuitry 201 of FIG. 2, cause the object detector circuitry 201 to train a neural network to determine width and/or height of a grouping reference box (GRB) as part of a convolutional encoder-decoder network for keypoint-based detection. In the example of FIG. 7, the trainer 358 accesses training data 354 (block 705). The training data 354 can include identified dimensions of one or more GRBs. The trainer 358 identifies data features represented by the training data 354 ((block 710). The training controller 356 instructs the trainer 358 to perform training of the neural network using the training data 354 to generate a reference box model 364 (block 715). In some examples, additional training is performed to refine the model 364 (block 720).

FIG. 8 illustrates example steps of an algorithm 800 representative of the soft-grouping (SG) and non-maximum suppression (NMS) soft object detection disclosed herein. In the example of FIG. 8, the SG-NMS algorithm 800 receives an input including grouping boxes in an image for one category (e.g., β={b₁, b₂, b₃, . . . b_{N}}) where each box includes an identification associated with the location where a given corner of the grouping box is extracted (e.g., using heatmap-based identification of top-left, bottom-right, top-right, bottom-left corner(s)). For example, the identifications and maximum/minimum coordinates associated with the corner point(s) can be defined as b=[id, xmin, ymin, xmax, ymax]. Furthermore, the input to the SG-NMS algorithm 800 includes a set of scores S associated with the bounding box(es), the Intersection over Union (IoU) metric, and grouping score thresholds (τᵢ and τ_{g}), as shown using example code line(s) 805. In the example of FIG. 8, the output of the SG-NMS algorithm 800 is a detection bounding box ( [symbol] ) with score S. The output shown using example code line(s) 810 includes an iterative loop (e.g., shown using example code line(s) 810, 815, 820). For example, iterative loop can proceed while all the grouping boxes in an image for one category have not been assessed (e.g., β≠EMPTY). As previously described, the SG-NMS algorithm 800 removes any GRB-based bₖ having greater overlap with a GRB-based top score, M (e.g., using vanilla NMS). Unlike regular NMS, the SG-NMS algorithm 800 also retains the coordinate values xmin, ymin, xmax and/or ymax in M that are extracted in heatmaps and exchanges other coordinate values with the estimated ones in bₖ, as shown in connection with example code line(s) 810, 815, 820. Compared with vanilla NMS, the SG-NMS algorithm 800 relies on a few code line changes without a large computational overhead. For example, if not all four corners are wrongly estimated for an object, SG-NMS, as a grouping algorithm, does not miss an object. Even three of four corners can provide a challenging sample to assess, and when only one corner is effectively predicted, SG-NMS retains one GRB as a detection result to prevent missing an object. If any corners with different location IDs are effectively estimated, two corresponding rough GRBs can turn into a more refined detection box through SG-NMS.

FIG. 9 illustrates an example chart 900 showing object detection performance using anchor-based and anchor-free methods, including the soft-grouping (SG) and non-maximum suppression (NMS) soft object detection disclosed herein. In the example of FIG. 9, a select method of assessment can include object detectors such as anchor-based object detector 910, anchor-free object detector (Dense Regression, DR) 912, anchor-free object detector (Keypoint Based, KB) 914, and/or an SGCDet 916. The object detector(s) 910, 912, 914, 916 include a backbone 902, an input resolution 904, a first set of test results 906, and a second set of test results 908. For example, the SG-NMS algorithm can be added to CornerNet by replacing original grouping and NMS operators to yield the SGCDet 916. SGCDet 916 can be compared with the state-of-the-art corner-based detectors 910, 912, 914. To better measure the performance of the SGCDet 916 model, multiple classic detectors can be compared in other existing types (e.g., anchor-based vs. anchor-free). Employing the smallest input resolution, SGCDet 916 achieves a mean average precision (AP) of 46.7% in single-scale testing without any tricks, outperforming all reported anchor-free detectors, even on-par with the advanced anchor-based detectors. Meanwhile, SGCDet 916 yields an AP₇₅ of 50.2%, showing that generated detection boxes are more refined as compared to using other known object detector(s). For example, the AP₅₀ and AP₇₅ data corresponds to an IoU threshold between detected bounding box(es) and ground-truth bounding box(es), as defined by an MS-COCO dataset (e.g., large-scale object detection, segmentation, and captioning dataset). For small objects, the SGCDet 916 also achieves improved accuracy with an APs of 27.8%. For example, APs corresponds to small object detection, APM corresponds to medium object detection, and API, corresponds to large object detection. These experimental results demonstrate the effectiveness of the SGCDet 916 algorithm described herein. In particular, SGCDet 916 achieves a significant 6.2% boosting on AP compared with the CornerNet baseline. Example inference speed comparison 918 (e.g., using a frames per second (FPS) measurement) with other example keypoint-based detectors 920, 922, 924, 926 also shows improvements when using the SGCDet 916 algorithm (e.g., using an Hourglass-104 backbone for all models). For example, the speed of SGCDet 916 (e.g., disclosed net 928) with Hourglass-104 is 9.1 FPS, which is much faster than other known keypoint-based detectors 920, 922, 924, 926 (e.g., triple the speed of ExtremeNet and CenterNet as well as CentripetalNet and more than twice the speed of CornerNet baseline). Additionally, the known models 920, 922, 924, 926 regard the grouping as an additional stage in post-processing and use flip-image augmentation as default in the inference to lift their accuracy (e.g., as shown in connection with FIG. 1). The design of these known models 920, 922, 924, 926 thereby affect the speed of inference, leading to low efficiency.

FIG. 10 is a block diagram of an example processor platform 1000 structured to execute and/or instantiate the machine readable instructions and/or operations of FIGS. 4 and/or 6 to implement the object detector circuitry 201 of FIG. 2. The processor platform 1000 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1000 of the illustrated example includes processor circuitry 1012. The processor circuitry 1012 of the illustrated example is hardware. For example, the processor circuitry 1012 can be implemented by one or more integrated circuits, logic circuits, FPGAs microprocessors, CPUs, GPUs, DSPs, and/or microcontrollers from any desired family or manufacturer. The processor circuitry 1012 may be implemented by one or more semiconductor based (e.g., silicon based) devices. In this example, the processor circuitry 1012 implements the input receiver circuitry 302, the backbone generator circuitry 304, the grouping reference box generator circuitry 306, the dimension identifier circuitry 308, the regression map generator circuitry 310, the heatmap generator circuitry 312, the threshold identifier circuitry 314, the output generator circuitry 316, and/or the tester circuitry 318.

The processor circuitry 1012 of the illustrated example includes a local memory 1013 (e.g., a cache, registers, etc.). The processor circuitry 1012 of the illustrated example is in communication with a main memory including a volatile memory 1014 and a non-volatile memory 1016 by a bus 1018. The volatile memory 1014 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1016 may be implemented by flash memory and/or any other desired type of memory device. Access to the main memory 1014, 1016 of the illustrated example is controlled by a memory controller 1017.

The processor platform 1000 of the illustrated example also includes interface circuitry 1020. The interface circuitry 1120 may be implemented by hardware in accordance with any type of interface standard, such as an Ethernet interface, a universal serial bus (USB) interface, a Bluetooth® interface, a near field communication (NFC) interface, a PCI interface, and/or a PCIe interface.

In the illustrated example, one or more input devices 1022 are connected to the interface circuitry 1020. The input device(s) 1022 permit(s) a user to enter data and/or commands into the processor circuitry 1012. The input device(s) 1022 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1024 are also connected to the interface circuitry 1020 of the illustrated example. The output devices 1024 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1020 of the illustrated example, thus, typically includes a graphics driver card, a graphics driver chip, and/or graphics processor circuitry such as a GPU.

The interface circuitry 1020 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1026. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1000 of the illustrated example also includes one or more mass storage devices 1028 to store software and/or data. Examples of such mass storage devices 1028 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1032, which may be implemented by the machine readable instructions of FIGS. 4 and/or 6, may be stored in the mass storage device 1028, in the volatile memory 1014, in the non-volatile memory 1016, and/or on a removable non-transitory computer readable storage medium such as a CD or DVD.

FIG. 11 is a block diagram of an example processing platform 1100 structured to execute the instructions of FIG. 5 to implement the example first computing system 325 of FIG. 3. The processor platform 1100 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1100 of the illustrated example includes a processor 1112. The processor 1112 of the illustrated example is hardware. For example, the processor 1112 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example neural network processor 336, the example trainer 334, and the example training controller 332.

The processor 1112 of the illustrated example includes a local memory 1113 (e.g., a cache). The processor 1112 of the illustrated example is in communication with a main memory including a volatile memory 1114 and a non-volatile memory 1116 via a bus 1118. The volatile memory 1114 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1116 may be implemented by flash memory and/or any other desired type of memory device. Access to the main memory 1114, 1116 is controlled by a memory controller.

The processor platform 1100 of the illustrated example also includes an interface circuit 1120. The interface circuit 1120 may be implemented by any type of interface standard, such as an Ethernet interface, a universal serial bus (USB), a Bluetooth® interface, a near field communication (NFC) interface, and/or a PCI express interface.

In the illustrated example, one or more input devices 1122 are connected to the interface circuit 1120. The input device(s) 1122 permit(s) a user to enter data and/or commands into the processor 1112. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1124 are also connected to the interface circuit 1120 of the illustrated example. The output devices 1124 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1120 of the illustrated example, thus, typically includes a graphics driver card, a graphics driver chip and/or a graphics driver processor.

The interface circuit 1120 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1126. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1100 of the illustrated example also includes one or more mass storage devices 1128 for storing software and/or data. Examples of such mass storage devices 1128 include floppy disk drives, hard drive disks, compact disk drives, Blu-ray disk drives, redundant array of independent disks (RAID) systems, and digital versatile disk (DVD) drives.

The machine executable instructions 408 of FIG. 5 may be stored in the mass storage device 1128, in the volatile memory 1114, in the non-volatile memory 1116, and/or on a removable non-transitory computer readable storage medium such as a CD or DVD.

FIG. 12 is a block diagram of an example processing platform 1200 structured to execute the instructions of FIG. 7 to implement the example second computing system 350 of FIG. 3. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, or any other type of computing device.

The processor platform 1200 of the illustrated example includes a processor 1212. The processor 1212 of the illustrated example is hardware. For example, the processor 1212 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example neural network processor 360, the example trainer 358, and the example training controller 356.

The processor 1212 of the illustrated example includes a local memory 1213 (e.g., a cache). The processor 1212 of the illustrated example is in communication with a main memory including a volatile memory 1214 and a non-volatile memory 1216 via a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 1216 may be implemented by flash memory and/or any other desired type of memory device. Access to the main memory 1214, 1216 is controlled by a memory controller.

The processor platform 1200 of the illustrated example also includes an interface circuit 1220. The interface circuit 1220 may be implemented by any type of interface standard, such as an Ethernet interface, a universal serial bus (USB), a Bluetooth® interface, a near field communication (NFC) interface, and/or a PCI express interface.

In the illustrated example, one or more input devices 1222 are connected to the interface circuit 1220. The input device(s) 1222 permit(s) a user to enter data and/or commands into the processor 1212. The input device(s) can be implemented by, for example, an audio sensor, a microphone, a camera (still or video), a keyboard, a button, a mouse, a touchscreen, a trackpad, a trackball, isopoint and/or a voice recognition system.

One or more output devices 1224 are also connected to the interface circuit 1220 of the illustrated example. The output devices 1224 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 1220 of the illustrated example, thus, typically includes a graphics driver card, a graphics driver chip and/or a graphics driver processor.

The interface circuit 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 1226. The communication can be via, for example, an Ethernet connection, a digital subscriber line (DSL) connection, a telephone line connection, a coaxial cable system, a satellite system, a line-of-site wireless system, a cellular telephone system, etc.

The processor platform 1200 of the illustrated example also includes one or more mass storage devices 1228 for storing software and/or data. Examples of such mass storage devices 1228 include floppy disk drives, hard drive disks, compact disk drives, Blu-ray disk drives, redundant array of independent disks (RAID) systems, and digital versatile disk (DVD) drives.

The machine executable instructions 615 of FIG. 7 may be stored in the mass storage device 1228, in the volatile memory 1214, in the non-volatile memory 1216, and/or on a removable non-transitory computer readable storage medium such as a CD or DVD.

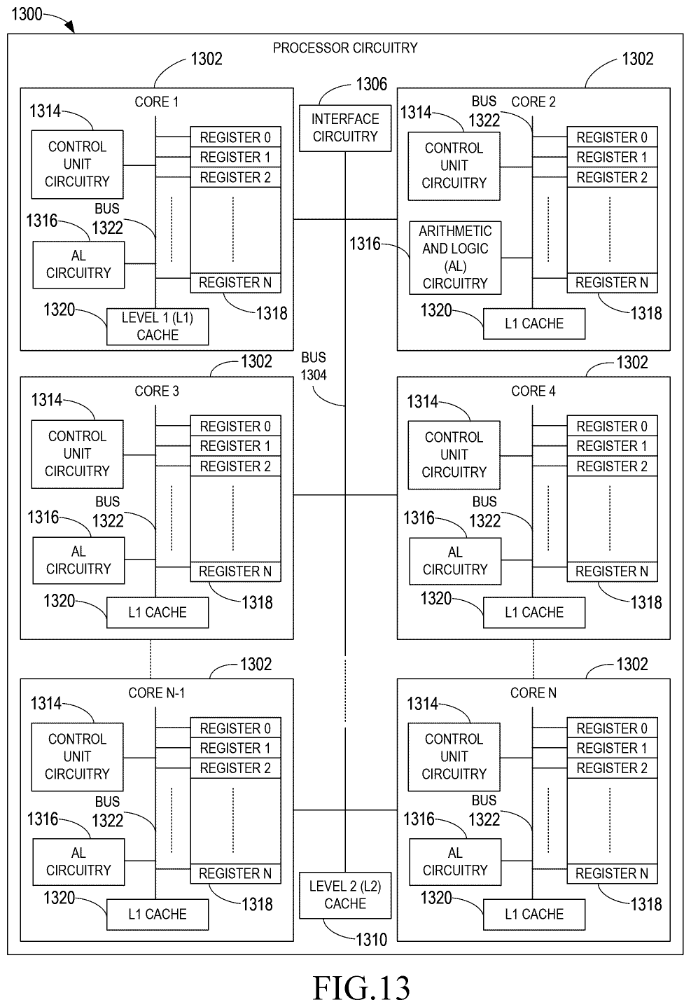

FIG. 13 is a block diagram of an example implementation of the processor circuitry 1012, 1112, 1312 of FIGS. 10, 11, 12. In this example, the processor circuitry 1012, 1112, 1312 of FIGS. 10, 11, 12 is implemented by a microprocessor 1300. For example, the microprocessor 1300 may implement multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowchart of FIGS. 4, 5, 6, and/or 7.

The cores 1302 may communicate by an example bus 1304. In some examples, the bus 1304 may implement a communication bus to effectuate communication associated with one(s) of the cores 1302. For example, the bus 1304 may implement at least one of an Inter-Integrated Circuit (I2C) bus, a Serial Peripheral Interface (SPI) bus, a PCI bus, or a PCIe bus. Additionally or alternatively, the bus 1304 may implement any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2_cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1014, 1016 of FIG. 10). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the L1 cache 1320, and an example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer-based operations. In other examples, the AL circuitry 1316 also performs floating point operations. In yet other examples, the AL circuitry 1316 may include first AL circuitry that performs integer-based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The bus 1322 may implement at least one of an I2C bus, a SPI bus, a PCI bus, or a PCIe bus.

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

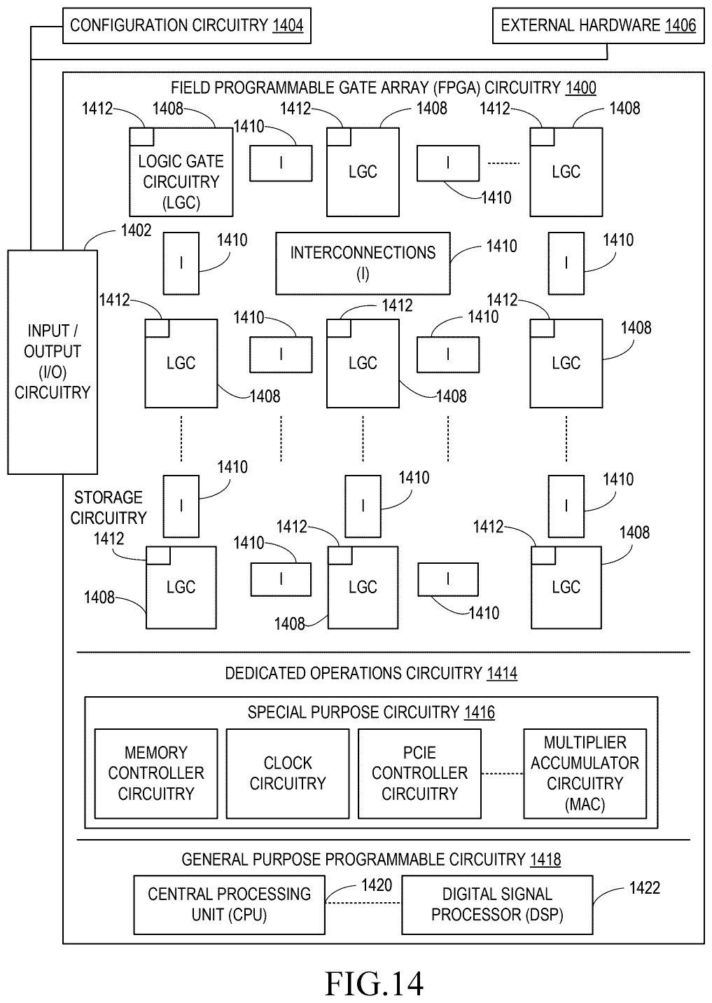

FIG. 14 is a block diagram of another example implementation of the processor circuitry 1012, 1112, 1212 of FIGS. 10, 11, 12. In this example, the processor circuitry 1012, 1112, 1212 is implemented by FPGA circuitry 1400. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowchart of FIGS. 4, 5, 6 and/or 7 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowchart of FIGS. 4, 5, 6, and/or 7. In particular, the FPGA 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowchart of FIGS. 4, 5, 6, and/or 7. As such, the FPGA circuitry 1400 may be structured to effectively instantiate some or all of the machine readable instructions of the flowchart of FIGS. 4, 5, 6, and/or 7 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 4, 5, 6, and/or 7 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware (e.g., external hardware circuitry) 1406. For example, the configuration circuitry 1404 may implement interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may implement the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and interconnections 1410 are configurable to instantiate one or more operations that may correspond to at least some of the machine readable instructions of FIGS. 4, 5, 6, and/or 7 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1012, 1112, 1212 of FIGS. 10, 11, and/or 12, many other approaches are contemplated. For example, as mentioned above, modern FPGA circuitry may include an on-board CPU, such as one or more of the example CPU 1420 of FIG. 14. Therefore, the processor circuitry 1012, 1112, 1212 of FIGS. 10, 11, and/or 12 may additionally be implemented by combining the example microprocessor 1300 of FIG. 13 and the example FPGA circuitry 1400 of FIG. 14. In some such hybrid examples, a first portion of the machine readable instructions represented by the flowchart of FIGS. 4, 5, 6, and/or 7 may be executed by one or more of the cores 1302 of FIG. 13 and a second portion of the machine readable instructions represented by the flowchart of FIGS. 4, 5, 6, and/or 7 may be executed by the FPGA circuitry 1400 of FIG. 14.

In some examples, the processor circuitry 1012, 1112, 1212 of FIGS. 10, 11, and/or 12 may be in one or more packages. For example, the processor circuitry 1300 of FIG. 13 and/or the FPGA circuitry 1400 of FIG. 14 may be in one or more packages. In some examples, an XPU may be implemented by the processor circuitry 1012, 1112, 1212 of FIGS. 10, 11, and/or 12 which may be in one or more packages. For example, the XPU may include a CPU in one package, a DSP in another package, a GPU in yet another package, and an FPGA in still yet another package.

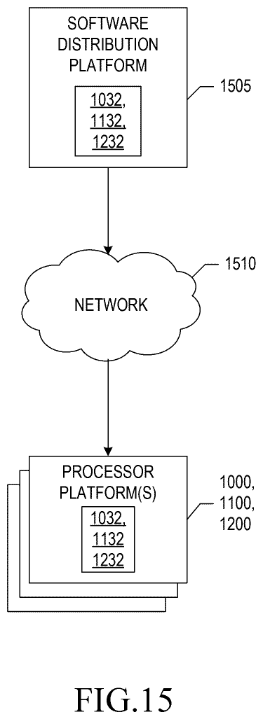

A block diagram illustrating an example software distribution platform 1505 to distribute software such as the example machine readable instructions 1032, 1132, 1232 of FIGS. 10, 11, 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1032, 1132, 1232 of FIGS. 10, 11, and/or 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1032, 1132, 1232, which may correspond to the example machine readable instructions 400, 408, 415, 615 of FIGS. 4, 5, 6, and/or 7, as described above. The one or more servers of the example software distribution platform 1505 are in communication with a network 1510, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1032, 1132, 1232 from the software distribution platform 1505. For example, the software, which may correspond to the example machine readable instructions 400, 408, 415, 615 of FIGS. 4, 5, 6, and/or 7, may be downloaded to the example processor platform 1000, 1100, 1200 which is to execute the machine readable instructions 1032, 1132, 1232 to implement the object identifier circuitry 201. In some example, one or more servers of the software distribution platform 1505 periodically offer, transmit, and/or force updates to the software (e.g., the example machine readable instructions 1032, 1132, 1232 of FIGS. 10, 11, 12) to ensure improvements, patches, updates, etc., are distributed and applied to the software at the end user devices.

From the foregoing, it will be appreciated that example systems, methods, apparatus, and articles of manufacture have been disclosed that introduce small object detection in images and/or videos using a simplified pipeline to improve object detection efficiency. In the examples disclosed herein, grouping and NMS phases are merged into a single stage and/or can share a distance metric calculation. Additionally, method and apparatus disclosed herein allow for a varied number of corner point(s) to boost object detection accuracy. In examples disclosed herein, Soft-Grouping Non-Maximum Suppression (SG-NMS) can be used for object detection by merging soft grouping with NMS into a single phase. As such, instead of using two separate distance metric calculations, distance computations can be shared between the SG and NMS stages for improved efficiency. In addition, a flexible number of estimated corners (e.g., 1 to 4) can be used while existing methods of keypoint-based object detection can depend on one fixed pair of two corners. Using methods and apparatus disclosed herein, the mean average precision for object detection is significantly improved.

Example methods and apparatus for small object detection in images and videos are disclosed herein. Further examples and combinations thereof include the following:

Example 1 includes an apparatus for object detection, comprising at least one memory, instructions in the apparatus, and processor circuitry to execute the instructions to receive an input image, identify a first grouping reference box for a first object representation in the input image, the first grouping reference box based on feature extraction performed with a feature extractor network, extract a first coordinate and a second coordinate for a corner location from a heatmap, the heatmap used to determine the first grouping reference box, generate a second grouping reference box for the first object representation based on the corner location, and when the corner location of the first grouping reference box surpasses a corner location threshold of the second grouping reference box, update the first grouping reference box with the second grouping reference box.

Example 2 includes the apparatus of example 1, wherein the feature extractor network is a convolutional encoder-decoder network for keypoint-based detection.

Example 3 includes the apparatus of example 1, wherein, when the corner location includes a first corner location and a second corner location, the processor circuitry is to group the first corner location and the second corner location using a soft-grouping (SG) algorithm and a non-maximum suppression (NMS) algorithm.

Example 4 includes the apparatus of example 3, wherein the processor circuitry is to determine a distance metric corresponding to the first grouping reference box and the second grouping reference box, the distance metric shared between the SG algorithm and the NMS algorithm.

Example 5 includes the apparatus of example 4, wherein the distance metric is an Intersection over Union (IoU) distance metric determined as part of the NMS algorithm.

Example 6 includes the apparatus of example 1, wherein the processor circuitry is to train a reference box model to determine a width and a height of the second grouping reference box.

Example 7 includes the apparatus of example 6, wherein the processor circuitry is to generate a regression map for the second grouping reference box, the regression map a four two-dimensional regression map identified using smooth L1 training of the reference box model.

Example 8 includes a method for object detection, the method comprising receiving an input image, identify a first grouping reference box for a first object representation in the input image, the first grouping reference box based on feature extraction performed with a feature extractor network, extracting a first coordinate and a second coordinate for a corner location from a heatmap, the heatmap used to determine the first grouping reference box, generating a second grouping reference box for the first object representation based on the corner location, and when the corner location of the first grouping reference box surpasses a corner location threshold of the second grouping reference box, updating the first grouping reference box with the second grouping reference box.

Example 9 includes the method of example 8, wherein the feature extractor network is a convolutional encoder-decoder network for keypoint-based detection.

Example 10 includes the method of example 8, wherein, when the corner location includes a first corner location and a second corner location, further including grouping the first corner location and the second corner location using a soft-grouping (SG) algorithm and a non-maximum suppression (NMS) algorithm.

Example 11 includes the method of example 10, further including determining a distance metric corresponding to the first grouping reference box and the second grouping reference box, the distance metric shared between the SG algorithm and the NMS algorithm.

Example 12 includes the method of example 11, wherein the distance metric is an Intersection over Union (IoU) distance metric determined as part of the NMS algorithm.

Example 13 includes the method of example 8, further including training a reference box model to determine a width and a height of the second grouping reference box.

Example 14 includes the method of example 13, further including generating a regression map for the second grouping reference box, the regression map a four two-dimensional regression map identified using smooth L1 training of the reference box model.

Example 15 includes a non-transitory computer readable storage medium comprising instructions that, when executed, cause a processor to at least receive an input image, identify a first grouping reference box for a first object representation in the input image, the first grouping reference box based on feature extraction performed with a feature extractor network, extract a first coordinate and a second coordinate for a corner location from a heatmap, the heatmap used to determine the first grouping reference box, generate a second grouping reference box for the first object representation based on the corner location, and when the corner location of the first grouping reference box surpasses a corner location threshold of the second grouping reference box, update the first grouping reference box with the second grouping reference box.

Example 16 includes the non-transitory computer readable storage medium of example 15, wherein the instructions, when executed, cause a processor to group a first corner location and a second corner location using a soft-grouping (SG) algorithm and a non-maximum suppression (NMS) algorithm.

Example 17 includes the non-transitory computer readable storage medium of example 16, wherein the instructions, when executed, cause a processor to determine a distance metric corresponding to the first grouping reference box and the second grouping reference box, the distance metric shared between the SG algorithm and the NMS algorithm.

Example 18 includes the non-transitory computer readable storage medium of example 15, wherein the instructions, when executed, cause a processor to train a reference box model to determine a width and a height of the second grouping reference box.

Example 19 includes the non-transitory computer readable storage medium of example 18, wherein the instructions, when executed, cause a processor to generate a regression map for the second grouping reference box, the regression map a four two-dimensional regression map identified using smooth L1 training of the reference box model.

Example 20 includes the non-transitory computer readable storage medium of example 15, wherein the feature extractor network is a convolutional encoder-decoder network for keypoint-based detection.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

1. An apparatus for object detection, comprising:
interface circuitry;
machine-readable instructions; and
at least one processor circuit to be programmed by the machine-readable instructions to:
receive an input image;
identify a first grouping reference box for a first object representation in the input image, the first grouping reference box based on feature extraction performed with a feature extractor network;
extract a first coordinate and a second coordinate for a corner location from a heatmap, the heatmap used to determine the first grouping reference box;
generate a second grouping reference box for the first object representation based on the corner location; and
when the corner location of the first grouping reference box surpasses a corner location threshold of the second grouping reference box, update the first grouping reference box with the second grouping reference box.

2. The apparatus of claim 1, wherein the feature extractor network is a convolutional encoder-decoder network for keypoint-based detection.

3. The apparatus of claim 1, wherein, when the corner location includes a first corner location and a second corner location, one or more of the at least one processor circuit is to group the first corner location and the second corner location using a soft-grouping (SG) algorithm and a non-maximum suppression (NMS) algorithm.

4. The apparatus of claim 3, wherein one or more of the at least one processor circuit is to determine a distance metric corresponding to the first grouping reference box and the second grouping reference box, the distance metric shared between the SG algorithm and the NMS algorithm.

5. The apparatus of claim 4, wherein the distance metric is an Intersection over Union (IoU) distance metric determined as part of the NMS algorithm.

6. The apparatus of claim 1, wherein one or more of the at least one processor circuit is to train a reference box model to determine a width and a height of the second grouping reference box.

7. The apparatus of claim 6, wherein one or more of the at least one processor circuit is to generate a regression map for the second grouping reference box, the regression map a four two-dimensional regression map identified using smooth L1 training of the reference box model.

8. A method for object detection, the method comprising:
receiving an input image;
identifying, by at least one processor circuit programmed by at least one instruction, a first grouping reference box for a first object representation in the input image, the first grouping reference box based on feature extraction performed with a feature extractor network;
extracting, by one or more of the at least one processor circuit, a first coordinate and a second coordinate for a corner location from a heatmap, the heatmap used to determine the first grouping reference box;
generating a second grouping reference box for the first object representation based on the corner location; and
when the corner location of the first grouping reference box surpasses a corner location threshold of the second grouping reference box, updating the first grouping reference box with the second grouping reference box.

9. The method of claim 8, wherein the feature extractor network is a convolutional encoder-decoder network for keypoint-based detection.

10. The method of claim 8, wherein, when the corner location includes a first corner location and a second corner location, further including grouping the first corner location and the second corner location using a soft-grouping (SG) algorithm and a non-maximum suppression (NMS) algorithm.

11. The method of claim 10, further including determining a distance metric corresponding to the first grouping reference box and the second grouping reference box, the distance metric shared between the SG algorithm and the NMS algorithm.

12. The method of claim 11, wherein the distance metric is an Intersection over Union (IoU) distance metric determined as part of the NMS algorithm.

13. The method of claim 8, further including training a reference box model to determine a width and a height of the second grouping reference box.

14. The method of claim 13, further including generating a regression map for the second grouping reference box, the regression map a four two-dimensional regression map identified using smooth L1 training of the reference box model.

15. At least one non-transitory machine-readable medium comprising machine-readable instructions to cause at least one processor circuit to at least:
receive an input image;
identify a first grouping reference box for a first object representation in the input image, the first grouping reference box based on feature extraction performed with a feature extractor network;
extract a first coordinate and a second coordinate for a corner location from a heatmap, the heatmap used to determine the first grouping reference box;
generate a second grouping reference box for the first object representation based on the corner location; and
when the corner location of the first grouping reference box surpasses a corner location threshold of the second grouping reference box, update the first grouping reference box with the second grouping reference box.

16. The at least one non-transitory machine-readable medium of claim 15, wherein the machine-readable instructions are to cause one or more of the at least one processor circuit to group a first corner location and a second corner location using a soft-grouping (SG) algorithm and a non-maximum suppression (NMS) algorithm.

17. The at least one non-transitory machine-readable medium of claim 16, wherein the machine-readable instructions are to cause one or more of the at least one processor circuit to determine a distance metric corresponding to the first grouping reference box and the second grouping reference box, the distance metric shared between the SG algorithm and the NMS algorithm.

18. The at least one non-transitory machine-readable medium of claim 15, wherein the machine-readable instructions are to cause one or more of the at least one processor circuit to train a reference box model to determine a width and a height of the second grouping reference box.

19. The at least one non-transitory machine-readable medium of claim 18, wherein the machine-readable instructions are to cause one or more of the at least one processor circuit to generate a regression map for the second grouping reference box, the regression map a four two-dimensional regression map identified using smooth L1 training of the reference box model.

20. The at least one non-transitory machine-readable medium of claim 15, wherein the feature extractor network is a convolutional encoder-decoder network for keypoint-based detection.
